(19) United States
(12) Patent Application Publication
(10) Pub. No.: US 2026/0127484 A1
(43) Pub. Date: May 7, 2026

(54) PERSONALIZED EXPLAINABILITY USING SHAP AND LLMS

(71) Applicant: INTUIT INC., Mountain View, CA (US)

(72) Inventors: Natalie Bar ELIYAHU, Tel Aviv (IL); Shon MENDELSON, Tel Aviv (IL); Hadas BAUMER, Tel Aviv (IL); Lior TABORI, Tel Aviv (IL)

(73) Assignee: INTUIT INC., Mountain View, CA (US)

(21) Appl. No.: 18/935,245

(22) Filed: Nov. 1, 2024

(51) Int. Cl. G06N 20/00

(52) U.S. Cl. CPC G06N 20/00

(57) ABSTRACT

A system and method for generating personalized explanations for AI model predictions. Operations may involve using an AI model to make inferences, determining the importance of different factors used in those inferences, and creating customized explanation prompts. Explainable AI techniques may be used to generate these prompts, taking into account the specific features involved in the inference as well as relevant information about the intended audience. A natural language processing component may use these prompts to produce explanations tailored to the target audience, making the AI's decision-making process more understandable. Feedback from users about these explanations may be obtained and used to refine and improve its explanation generation process over time.

### BACKGROUND

Explainable Artificial Intelligence (XAI) has emerged as a field in the development and deployment of AI systems across various domains. As AI models become increasingly complex and are applied to high-stakes decision-making processes, there is a growing need for transparency and interpretability in their outputs. Current XAI approaches often focus on providing feature importance scores or model-agnostic explanations and attention mechanisms in neural networks. These methods aim to shed light on the inner workings of AI models and help users understand the factors influencing AI-driven decisions.

However, existing XAI techniques face several limitations that hinder their effectiveness in real-world applications. Many of these methods generate technical explanations that are not easily understood by non-expert users, creating a gap between the AI system and its intended audience. Additionally, current approaches often fail to account for the diverse backgrounds, roles, and needs of different stakeholders interacting with AI systems. This one-size-fits-all approach to explanations can lead to confusion, mistrust, and/or misinterpretation of AI outputs, which is undesirable. Furthermore, the lack of personalization in XAI methods may result in explanations that are either too simplistic or overly complex for specific users, reducing their practical value in decision-making processes, which is also undesirable.

### SUMMARY

Embodiments disclosed herein solve the aforementioned technical problems and may provide other technical solutions as well. Contrary to conventional techniques, the disclosed solution includes a novel method and system for generating personalized explanations for AI model predictions. For example, the disclosed operations may involve using an AI model to make inferences, determining the importance of different factors used in those inferences, and creating customized explanation prompts. Explainable AI techniques may be used to generate these prompts, taking into account the specific features involved in the inferences as well as relevant information about the intended audience. A natural language processing component may use these prompts to produce explanations tailored to the target audience, making the AI's decision-making process more understandable.

An example embodiment includes a system for generating personalized explanations for AI model predictions, comprising a processor and a memory storing instructions that, when executed by the processor, cause the system to perform an inference with an inference model, extract Shapley (SHAP) values of corresponding features used by the inference model for the inference, generate, by an explainable AI (XAI), a personalized explanation prompt based on the corresponding features and contextual information of a target audience, and produce, by a large language model (LLM), a tailored explanation of the inference to the target audience based on the generated prompt. One or more embodiments may collect user feedback on the tailored explanation and fine-tune the XAI based on the collected feedback.

Another example embodiment includes a method of generating personalized explanations for AI model predictions, comprising performing an inference with an inference model, extracting Shapley (SHAP) values of corresponding features used by the inference model for the inference, generating, by an explainable AI (XAI), a personalized explanation prompt based on the corresponding features and contextual information of a target audience, and producing, by a large language model (LLM), a tailored explanation of the inference to the target audience based on the generated prompt. The method may also collect user feedback on the tailored explanation and fine-tune the XAI based on the collected feedback.

### BRIEF DESCRIPTION OF THE DRAWINGS

So that the present disclosure can be understood in detail, a more particular description of the disclosure, briefly summarized above, may be made by reference to example embodiments, some of which are illustrated in the appended drawings. It is to be noted, however, that the appended drawings illustrate only example embodiments of this disclosure and are therefore not to be considered limiting of its scope, for the disclosure may apply to other equally effective example embodiments.

FIG. 1 illustrates a personalized explainable AI system, according to aspects of the present disclosure.

FIG. 2 depicts a block diagram of a system for generating personalized explanations, in accordance with example embodiments.

FIG. 3 shows a flowchart of a method for generating personalized explanations for AI model predictions, according to an embodiment.

FIG. 4 illustrates a flowchart of a method for extracting SHAP values and identifying influential features, according to aspects of the present disclosure.

FIG. 5 depicts a flowchart of a method for generating a personalized explanation prompt, in accordance with example embodiments.

FIG. 6 shows a flowchart of a method for fine-tuning an explainable AI system, according to an embodiment.

FIG. 7 illustrates a block diagram of a system for implementing the disclosed methods, according to aspects of the present disclosure.

### DETAILED DESCRIPTION OF SEVERAL EMBODIMENTS

The present disclosure provides a system and method for generating personalized explanations of artificial intelligence (AI) model predictions. This system and method address the challenge of making AI model predictions more understandable and relevant to diverse user groups. The system leverages the power of Shapley Additive exPlanations (SHAP) values to identify the influential features contributing to a model's prediction. These SHAP values are used to generate a personalized explanation prompt, which may be further processed by a large language model (LLM) to produce a tailored explanation for the target audience.

The system also incorporates additional contextual information about the target audience, such as their role, technical expertise, industry, and preferred communication style, to further personalize the explanation. This approach ensures that the explanations are accurate in terms of the underlying AI model's decision-making process and also meaningful and actionable from the user's perspective.

Moreover, the system may include a feedback loop mechanism that allows for continuous improvement of the explanations based on user engagement and performance metrics. This feedback may be used to fine-tune the explainable AI (XAI) system, enhancing its ability to generate relevant and understandable explanations over time.

For instance, in a real-world application such as an autonomous invoice reminder system, the system may analyze transaction data, predict when to send invoice reminders, and generate a personalized explanation for the financial manager of a company. This explanation may highlight the key factors influencing the prediction (e.g., consistent 30-day intervals between invoices, similar invoice amounts, etc.) while also taking into account the manager's role, industry, and preferred communication style. The manager's interaction with the explanation may be recorded as feedback, which may be used to further refine the system's explanation generation capabilities.

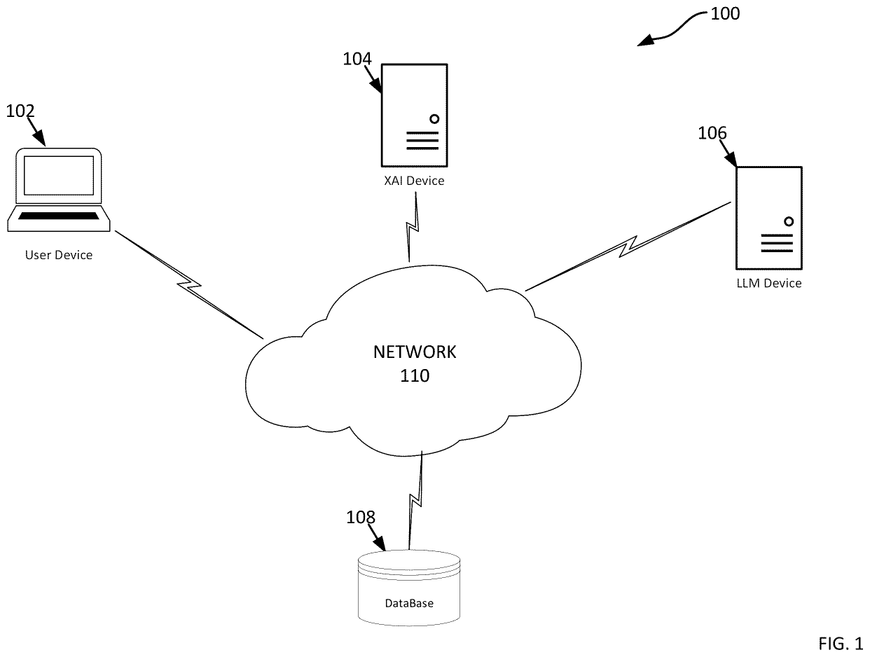

Referring to FIG. 1, an example personalized XAI system 100 according to the disclosed principles is now described. The system 100 may include several interconnected components including user device 102, XAI device 104, LLM device 106, database 108, communicating via a network 110 that may be a cloud-based or distributed network infrastructure, enabling data exchange and interaction between the components of the system 100.

User device 102, may be any computing device such as a laptop computer, desktop computer, tablet, smartphone, or any other suitable device. The user device 102 may be connected to the network 110, allowing it to interact with other components of the system 100. In some aspects, the user device 102 may be used by a user to provide input data, receive output data, or provide feedback on the system's performance.

XAI device 104 may be a server or any other suitable computing device capable of handling XAI computations or processes. In some embodiments, the XAI device 104 may be configured to perform an inference with an AI model, extract SHAP values from the model's predictions, and generate personalized explanation prompts based on the extracted SHAP values and additional contextual information about the target audience.

LLM device 106 may be a server or any other suitable computing device capable of handling LLM operations. In some aspects, the LLM device 106 may be configured to receive the personalized explanation prompts from the XAI device 104 and generate tailored explanations based on these prompts.

Database 108 may store data relevant to the system's operations, such as user information, AI models, explanation data, and user feedback. In some embodiments, the database 108 may be accessed by the XAI device 104 and the LLM device 106 to retrieve or store data as needed.

In some aspects, the system 100 may be configured to continuously improve its explanations based on user feedback. For example, the system 100 may collect user feedback via the user device 102, analyze the feedback to identify low-performing explanations, gather additional topic and audience data related to the low-performing explanations, and fine-tune the XAI device 104 using the additional data to improve subsequent explanation generation. This feedback loop mechanism allows the system 100 to adapt to the diverse needs and preferences of different user groups, enhancing the transparency, accountability, and user-friendliness of AI systems.

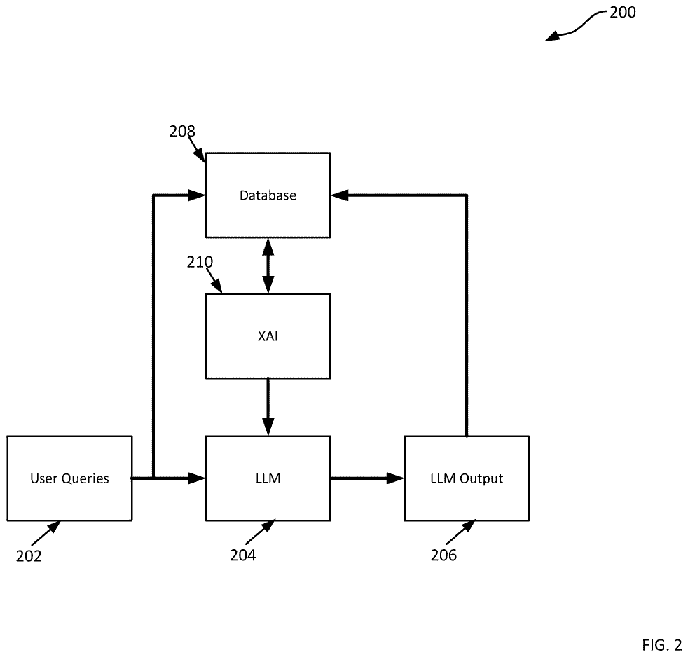

Referring to FIG. 2, a block diagram of an example system 200 for generating personalized explanations according to the disclosed principles is now described. The system 200 may include several components, such as a user query module 202, an LLM module 204, an output module 206, a database 208, and an XAI module 210.

The user query module 202 may be configured to receive user queries and forward them to the LLM module 204. In some aspects, the user queries may include requests for explanations of AI model predictions, requests for information about specific features or factors influencing the predictions, or any other suitable queries related to the AI model's operations.

The LLM module 204 may be configured to process the user queries and interact with other components of the system 200. In some embodiments, the LLM module 204 generates personalized explanations based on the user queries, features corresponding to the extracted SHAP values, and additional contextual information about the target audience. In some embodiments, the LLM module 204 utilizes an LLM to generate these explanations in a natural language format that is understandable and relevant to the target audience.

The output module 206 may be configured to present the generated explanations to the user. In some aspects, the output module 206 may display the explanations on a user interface, send the explanations to the user via email or other communication channels, or provide the explanations in any other suitable format.

The database 208 may be configured to store relevant information for the system's operations. This information may include user information, AI models, explanation data, SHAP values, and user feedback. In some embodiments, the database 208 may be accessed by the LLM module 204 and the XAI module 210 to retrieve or store data as needed.

The XAI module 210 may be configured to process information from the database 208 and provide input to the LLM module 204. In some aspects, the XAI module 210 calculates SHAP values for the features used in the AI model's predictions, identifies the influential features based on these SHAP values, and generates personalized explanation prompts based on the identified features and additional contextual information about the target audience. In the context of an autonomous invoice reminder system, influential features may include consistent payment intervals, invoice amounts, and customer payment history. Contextual information for the target audience may encompass the financial manager's role, industry expertise, and preferred communication style, which can be used to tailor the explanation to their specific needs and understanding.

In some aspects, the system 200 may be configured to continuously improve its explanations based on user feedback. For example, the system 200 may collect user feedback via the user query module 202, analyze the feedback to identify low-performing explanations, gather additional topic and audience data related to the low-performing explanations, and fine-tune the XAI module 210 using the additional data to improve subsequent explanation generation. This feedback loop mechanism allows the system 200 to adapt to the diverse needs and preferences of different user groups, enhancing the transparency, accountability, and user-friendliness of AI systems. In some aspects, user feedback may include ratings or scores indicating the clarity and relevance of the explanations provided by the system. Additionally, user feedback may encompass interaction data such as the time spent reviewing explanations, follow-up questions asked, or specific parts of the explanation that users found helpful or confusing.

In some aspects, the feedback collected by the system may be based simply on user interactions with the explanation. This approach allows for passive feedback collection without requiring explicit user input. For example, the system may track metrics such as the time spent viewing the explanation, which parts of the explanation the user focuses on, and/or whether the user requests additional information or clarification. These interaction-based metrics can provide insights into the effectiveness and relevance of the explanations.

In some embodiments, the system may analyze user navigation patterns within the explanation interface. For instance, if a user frequently scrolls back to a particular section of the explanation, it may indicate that this section may be important and/or potentially confusing. Similarly, if users consistently skip over parts of the explanation, it may suggest that these sections are less relevant and/or too complex for the target audience.

The system may also track whether users take specific actions after viewing the explanation, such as adjusting settings, making decisions based on the AI model's prediction, and/or seeking further information. These post-explanation behaviors can serve as implicit feedback on the explanation's clarity and actionability.

By leveraging these interaction-based feedback mechanisms, the system may continuously refine its approach to generating personalized explanations without placing additional burden on users to provide explicit feedback. This passive feedback collection can lead to a more seamless user experience while still providing data for improving the XAI system.

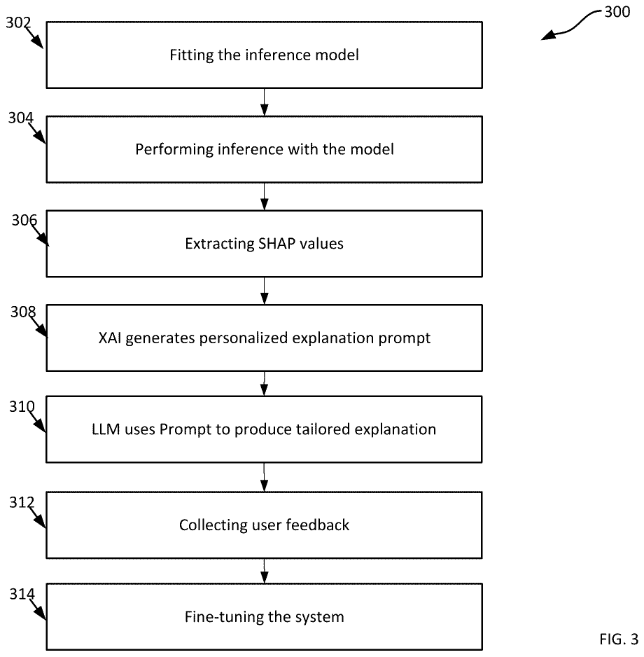

The methods performed by the devices illustrated in FIG. 1 and FIG. 2 are now described in detail through the flowcharts presented in FIGS. 3 through 6. These flowcharts provide a step-by-step breakdown of example processes involved in generating personalized explanations.

Referring to FIG. 3, a flowchart of an example method 300 of generating personalized explanations for AI model predictions according to the disclosed principles is now described. The method 300 may be implemented by the system 100 or system 200, as described above, or any other suitable system. In one or more embodiments, the method 300 includes step 302 (fitting an inference model), step 304 (performing inference), step 306 (extracting SHAP values), step 308 (generating a personalized explanation prompt), step 310 (producing a tailored explanation), step 312 (collecting user feedback), and step 314 (fine-tuning the XAI system).

The method 300 begins with step 302, which involves fitting an inference model. This step may involve training an AI model using a suitable dataset and a suitable machine learning algorithm. The inference model may be any suitable model capable of making predictions or decisions based on input data, such as a neural network, a decision tree, a support vector machine, or any other suitable model. In some aspects, the fitting of the inference model may involve techniques such as cross-validation, regularization, or ensemble methods to improve the model's generalization capabilities. The model architecture may be selected based on the specific requirements of the task, such as interpretability needs or computational constraints. Additionally, the training process may incorporate techniques like transfer learning or fine-tuning to leverage pre-existing knowledge and improve model performance, especially in cases where labeled data may be limited.

The method 300 proceeds to step 304, which involves performing an inference with the fitted model. In this step, the fitted model may be used to analyze input data and generate a prediction or decision. The input data may be any suitable data relevant to the prediction or decision to be made by the model, such as e.g., transaction data in an invoice reminder system, patient data in a medical diagnosis support system, and/or any other suitable data.

In some embodiments, the inference performed in step 304 may involve additional preprocessing of the input data to ensure compatibility with the trained model. This may include normalization, feature scaling, and/or encoding categorical variables. The inference process may also incorporate uncertainty estimation techniques, providing confidence intervals or probability distributions for the model's predictions. In some implementations, the system may employ techniques like model ensembling or Monte Carlo dropout during inference to improve robustness and capture model uncertainty.

In step 306, the method 300 extracts SHAP values from the model's prediction. The SHAP values provide a measure of the contribution of each feature in the input data to the model's prediction. The extraction of SHAP values may involve calculating the SHAP values for the features used in the model, ranking the features based on their absolute SHAP values, and selecting the top K positive and negative SHAP values, where K is a predetermined number.

It is noted that SHAP values may provide a measure of each feature's contribution to a model's prediction by assigning importance scores to input features. These values may be based on game theory concepts, particularly SHAP values, and may aim to fairly distribute the impact of each feature on the model's output. SHAP values may allow for both global interpretability, showing overall feature importance across a dataset, and local interpretability, explaining individual predictions. In some embodiments, SHAP values may help in understanding complex models, identifying key factors influencing predictions, and potentially uncovering biases or unexpected behaviors in AI systems.

The method 300 proceeds to step 308, which involves generating a personalized explanation prompt using the XAI device 104. The personalized explanation prompt may be generated based on the features corresponding to the extracted SHAP values and additional contextual information about the target audience. The additional contextual information may include the target audience's role, technical expertise, industry, preferred communication style, and/or any other suitable information.

In some aspects, the personalized explanation prompt may be generated by combining the features corresponding to the extracted SHAP values with additional contextual information about the target audience. The XAI device 104 may retrieve relevant user data from the database 108, such as the user's role, technical expertise, and preferred communication style. This information may be integrated with the features corresponding to the SHAP values to create a prompt that highlights the influential features in a manner tailored to the user's background and needs. The prompt may also incorporate domain-specific terminology and examples that resonate with the target audience's industry or field of expertise. By synthesizing these elements, the system may produce a personalized explanation prompt that serves as a foundation for generating a clear, relevant, and actionable explanation of the AI model's prediction.

In step 310, the method 300 involves producing a tailored explanation using the LLM device 106 based on the generated prompt. The LLM device 106 may generate the tailored explanation in a natural language format that may be understandable and relevant to the target audience. The tailored explanation may include a description of the model's prediction, the influential features contributing to the prediction, and/or any other suitable information.

In some aspects, the LLM device 106 may employ advanced natural language generation techniques to create a coherent narrative that seamlessly incorporates technical details with contextual information. The system may implement adaptive weighting mechanisms to balance the emphasis on different types of information based on their relevance to the specific user and prediction context. Additionally, the tailored explanation may be structured to present information in an order that aligns with the target audience's preferred communication style, potentially enhancing the understandability and actionability of the explanation.

Following the production of the tailored explanation in step 310, the method 300 collects user feedback in step 312. The user feedback may be collected via the user device 102 and may include the user's interaction with the tailored explanation, the user's satisfaction with the explanation, the user's understanding of the explanation, and/or any other suitable feedback.

In some embodiments, the feedback collection process may employ passive tracking methods that do not require explicit user input. For example, the system may monitor metrics such as the time spent viewing different sections of the explanation, track user interactions like mouse movements or clicks on specific parts of the explanation and/or analyze the sequence in which users navigate through the explanation interface. These interaction-based metrics can provide insights into the effectiveness and relevance of the explanations without placing additional burden on users to provide explicit feedback. The system may also track whether users take specific actions after viewing the explanation, such as adjusting settings or seeking further information, which can serve as implicit feedback on the explanation's clarity and actionability.

The method 300 then proceeds with step 314, which involves fine-tuning the XAI system based on the collected feedback. The fine-tuning may involve adjusting the XAI system's explanation generation process to improve the relevance, understandability, or other aspects of generated explanations. The fine-tuning may be performed based on an analysis of the collected feedback, additional topic and audience data related to low-performing explanations, or any other suitable data or criteria.

In some aspects, fine-tuning of the XAI system may be performed using machine learning techniques to adjust the system's parameters based on the collected feedback and additional data. The fine-tuning process may involve updating the weights or parameters of the XAI model to optimize its performance in generating personalized explanations. This process may include techniques such as gradient descent, reinforcement learning, or transfer learning to name a few, depending on the specific architecture of the XAI system. The system may use the collected feedback as a form of supervised learning data, where the user interactions and ratings serve as indicators of explanation quality. Additionally, the fine-tuning process may incorporate new data related to low-performing explanations, allowing the system to adapt to previously challenging scenarios. This iterative approach to fine-tuning may enable the XAI system to continuously improve its ability to generate relevant, understandable, and actionable explanations for diverse user groups across various domains.

In the context of an autonomous invoice reminder system, the method 300 illustrated in FIG. 3 may be applied to generate personalized explanations for AI model predictions. The process begins with step 302, where an inference model is fitted using historical invoice and payment data. This model may be trained to predict optimal times for sending invoice reminders based on factors such as consistent payment intervals, invoice amounts, and customer payment history.

Following the model fitting, step 304 involves performing an inference with the fitted model. In this case, the model may analyze current transaction data for a specific customer and predict when to send the next invoice reminder. Step 306 extracts SHAP values from this prediction, identifying the influential features that contributed to the decision. For instance, the SHAP values may reveal that the customer's consistent 30-day payment interval and the invoice amount were key factors in determining the reminder timing. In step 308, the XAI device generates a personalized explanation prompt based on features corresponding to the SHAP values and contextual information about the target audience, such as the financial manager's role, industry expertise, and preferred communication style.

The LLM device then produces a tailored explanation in step 310, translating the technical SHAP values and model prediction into natural language that may be relevant and understandable to the financial manager. This explanation may highlight the key factors influencing the reminder timing decision in a way that aligns with the manager's expertise and industry context. Steps 312 and 314 involve collecting user feedback on this explanation and fine-tuning the XAI system accordingly. For example, if the financial manager frequently requests more details about aspects of the explanation, the system may adjust to provide more in-depth information on those topics in future explanations. This iterative process allows the system to continuously improve its ability to generate clear, relevant, and actionable explanations for the invoice reminder predictions, enhancing the financial manager's trust and understanding of the AI-driven decision-making process.

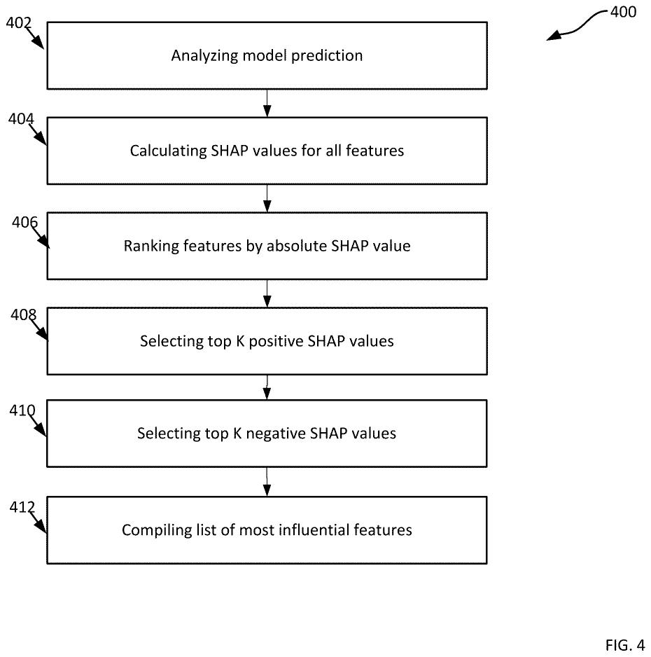

Referring to FIG. 4, a flowchart of an example method 400 of extracting SHAP values and identifying influential features according to the disclosed principles is now described. The method 400 may be implemented by the system 100 or system 200, as described above, or any other suitable system. In one or more embodiments, the method 400 includes step 402 (analyzing a model prediction), step 404 (calculating SHAP values for the features), step 406 (ranking features based on absolute SHAP values), step 408 (selecting top K positive SHAP values), step 410 (selecting top K negative SHAP values), and step 412 (compiling a list of influential features).

The method 400 begins with step 402, which involves analyzing a model prediction. This step may involve using the inference model to analyze input data and generate a prediction or decision. The input data may be any suitable data relevant to the prediction or decision to be made by the model, such as transaction data in an invoice reminder system, patient data in a medical diagnosis support system, and/or any other suitable data.

In some aspects, the analysis of the model prediction in step 402 may involve examining the output probabilities or scores for different classes in a classification task, or the predicted values in a regression task. This analysis may also include evaluating the confidence level of the prediction, identifying any anomalies or unexpected results, and comparing the prediction to historical data or predefined thresholds. Additionally, this step may involve preprocessing the input data, such as normalizing numerical features or encoding categorical variables, to ensure consistency with the model's training data.

The method 400 proceeds to step 404, which involves calculating SHAP values for the features used in the model. The SHAP values provide a measure of the contribution of each feature in the input data to the model's prediction. The calculation of SHAP values may involve using the SHAP algorithm or any other suitable algorithm to determine the SHAP values for each feature.

In some embodiments, the calculation of SHAP values may involve using techniques such as KernelSHAP for model-agnostic explanations or TreeSHAP for tree-based models. This step may also include handling computational challenges for high-dimensional datasets, such as using approximation methods or sampling techniques to reduce computation time. Furthermore, this step may involve addressing issues related to feature correlation and interaction effects between features, which can impact the interpretation of SHAP values.

In step 406, the method 400 performs ranking the features based on their absolute SHAP values. This step may involve sorting the features in descending order based on their absolute SHAP values, with the feature having the highest absolute SHAP value ranked first. This ranking provides an indication of the relative importance of each feature in contributing to the model's prediction.

The ranking process in step 406 may also involve additional considerations beyond simple sorting. For instance, it may include techniques to handle tied SHAP values, such as using secondary criteria like feature prevalence or domain knowledge. In some implementations, this step may also involve grouping related features or creating feature hierarchies to provide a more structured view of feature importance. Additionally, the ranking process may consider the stability of feature rankings across multiple predictions or different subsets of the data to ensure robustness.

The method 400 proceeds to step 408, which involves selecting the top K positive SHAP values. This step may involve selecting the K features with the highest positive SHAP values, where K is a predetermined number. These selected features are the influential features contributing positively to the model's prediction.

In some implementations, the selection of top K positive SHAP values in step 408 may involve more than just choosing a fixed number of features. It may include adaptive techniques that adjust K based on the distribution of SHAP values, such as selecting features until a percentage of the total positive impact may be accounted for. This step may also involve techniques to ensure diversity in the selected features, preventing the selection of highly correlated features that may provide redundant information. Furthermore, domain-specific constraints or user preferences may be incorporated to guide the selection process.

Subsequently, in step 410, the method 400 selects the top K negative SHAP values. This step may involve selecting the K features with the highest negative SHAP values. These selected features are the influential features contributing negatively to the model's prediction.

The selection of top K negative SHAP values in step 410 may mirror the process used for positive SHAP values, but with a focus on features that decrease the model's prediction. In some embodiments, this step may involve additional considerations specific to negative impacts, such as identifying potential confounding factors or unexpected relationships in the data. The selection process may also consider the magnitude of negative impacts relative to positive ones, potentially adjusting the number of selected negative features based on their overall influence on the prediction.

The method 400 concludes with step 412, which compiles a list of the influential features based on the selected positive and negative SHAP values. This list provides a comprehensive overview of the features that have a significant impact on the model's prediction, both positively and negatively.

In some aspects, the compilation of the influential features in step 412 may involve more than simply combining the lists from steps 408 and 410. It may include organizing the features into meaningful categories or hierarchies, providing context about the relative importance of positive versus negative influences, and potentially including visualizations to aid in interpretation. This step may also involve generating summary statistics or metrics that capture the overall feature importance landscape, such as the ratio of positive to negative influences or the concentration of impact among top features. Additionally, this compilation may be tailored to the specific needs or preferences of the target audience, adjusting the level of detail or technical complexity based on user profiles.

In the context of the autonomous invoice reminder system, the method 400 may be applied to extract SHAP values and identify influential features for generating personalized explanations of AI model predictions. The process begins with step 402, where the system analyzes the model's prediction for when to send the next invoice reminder to a specific customer. This analysis may involve examining the output of the inference model, which has processed current transaction data for the customer.

Following the analysis of the model prediction, step 404 involves calculating SHAP values for the features used in the model. In the invoice reminder system, these features may include the customer's payment history, consistent payment intervals, invoice amounts, seasonal trends, and/or other relevant factors. The SHAP algorithm may be applied to determine the contribution of each of these features to the model's decision on when to send the reminder. Step 406 then ranks these features based on their absolute SHAP values, providing a clear hierarchy of feature importance for this particular prediction.

Steps 408 and 410 involve selecting the top K positive and negative SHAP values, respectively. For the invoice reminder system, this may result in identifying features such as the customer's consistent 30-day payment interval and the invoice amount as top positive contributors, while factors like recent holidays or the day of the week may be identified as top negative contributors. The method concludes with step 412, compiling a list of these influential features. This comprehensive list may serve as the foundation for generating a personalized explanation to the financial manager, highlighting the key factors that influenced the AI's decision on when to send the invoice reminder, thereby enhancing transparency and trust in the system's recommendations.

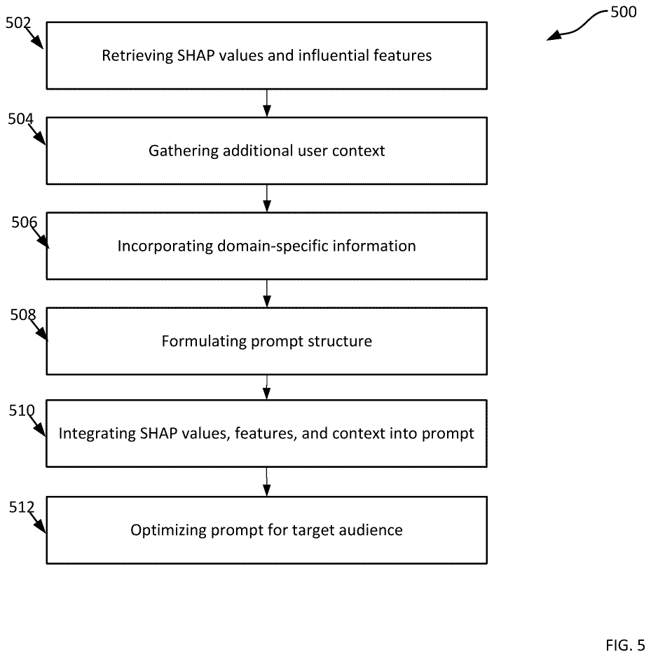

Referring to FIG. 5, a flowchart of a method 500 of generating a personalized explanation prompt according to the disclosed principles is now described. The method 500 may be implemented by the system 100 or system 200, as described above, or any other suitable system. In one or more embodiments, the method 500 includes step 502 (retrieving SHAP values and influential features), step 504 (gathering additional user context), step 506 (incorporating domain-specific information), step 508 (formulating the structure of the explanation prompt), step 510 (integrating the SHAP values, influential features, user context, and domain-specific information into the explanation prompt), and step 512 (optimizing the explanation prompt for the target audience).

The method 500 begins with step 502, which involves retrieving SHAP values and influential features. This step may involve accessing the database 108 or 208 to retrieve the SHAP values and influential features identified in the previous steps of the method. The SHAP values provide a measure of the contribution of each feature in the input data to the model's prediction, while the influential features represent the features with the highest positive or negative SHAP values. In some aspects, this retrieval process may involve querying multiple data sources or aggregating information from distributed systems to ensure a comprehensive collection of relevant SHAP values and features. The system may also implement caching mechanisms to optimize the retrieval process for frequently accessed data, potentially improving the overall efficiency of the explanation generation pipeline.

Following the retrieval of SHAP values and influential features in step 502, the method 500 proceeds to step 504, which involves gathering additional user context. This step may involve accessing user-specific information stored in the database 108 or 208, such as the user's role, technical expertise, industry, and preferred communication style. This additional user context provides information that can be used to tailor the explanation to the specific needs and preferences of the target audience. In some embodiments, the system may employ machine learning techniques to infer or predict aspects of user context based on historical interaction data or similar user profiles. The gathering process may also include real-time data collection, such as the user's current device type or location, to further refine the contextual understanding.

In step 506, the method 500 involves incorporating domain-specific information into the explanation prompt. This step may involve accessing domain-specific information stored in the database 108 or 208, such as industry trends, domain-specific terminology, or any other relevant information. This domain-specific information can help make the explanation more relevant and understandable to the target audience. In some aspects, the system may utilize natural language processing techniques to extract and categorize domain-specific information from various sources, including industry reports, academic publications, or expert knowledge bases. The incorporation process may also involve mapping domain-specific concepts to more general terms or vice versa, depending on the user's expertise level.

Following the incorporation of domain-specific information in step 506, the method 500 proceeds to step 508, which involves formulating the structure of the explanation prompt. This step may involve determining the order in which the information will be presented in the explanation, the level of detail to be included, and any other structural considerations. The structure of the explanation prompt can be tailored to the target audience's preferred communication style, enhancing the understandability of the explanation. In some embodiments, the system may employ template-based approaches, where multiple pre-defined structures are available and the appropriate one may be selected based on the user context and the nature of the prediction being explained. The formulation process may also consider factors such as the optimal length of the explanation or the inclusion of visual elements to support textual information.

In step 510, the method 500 involves integrating the influential features identified by the SHAP values, user context, and domain-specific information into the explanation prompt. This step may involve combining the gathered information into a coherent and structured explanation prompt that can be processed by the LLM device 106 or 204. The explanation prompt may be formulated in a way that highlights the influential features, provides context for the model's prediction, and presents the information in a user-friendly manner. In some aspects, this integration process may involve sophisticated natural language generation techniques to create a narrative flow that seamlessly incorporates technical details with contextual information. The system may also implement adaptive weighting mechanisms to balance the emphasis on different types of information based on their relevance to the specific user and prediction context.

The method 500 concludes with step 512, which involves optimizing the explanation prompt for the target audience. This step may involve fine-tuning the language, structure, and content of the explanation prompt based on the target audience's characteristics and preferences. The optimization process may involve using natural language processing techniques, user feedback, or any other suitable methods to ensure that the explanation prompt may be as relevant, understandable, and actionable as possible for the target audience. In some embodiments, the system may employ A/B testing methodologies to compare different versions of the explanation prompt and iteratively refine the optimization process. The optimization step may also include considerations for multi-modal explanations, potentially incorporating visual or interactive elements to enhance the effectiveness of the explanation for user groups or complex predictions.

In the context of the autonomous invoice reminder system, the method 500 illustrated in FIG. 5 may be applied to generate a personalized explanation prompt for the financial manager. The process begins with step 502, where the system retrieves the SHAP values and influential features identified in the previous steps. For the invoice reminder system, this may include retrieving the SHAP values associated with features such as the customer's consistent 30-day payment interval, invoice amount, and other relevant factors that influenced the AI's decision on when to send the reminder.

Step 504 involves gathering additional user context specific to the financial manager. This may include accessing information about the manager's role within the company, their level of technical expertise in AI and financial systems, their industry experience, and their preferred communication style. For example, the system may retrieve data indicating that the financial manager has a high level of financial expertise but limited technical knowledge of AI systems, and prefers concise, action-oriented explanations. In step 506, the system incorporates domain-specific information relevant to invoice management and the company's industry. This may include current industry payment trends, company-specific payment policies, or recent changes in financial regulations that may impact invoice timing.

The subsequent steps focus on crafting the explanation prompt. In step 508, the system formulates the structure of the prompt, potentially organizing it to first present the AI's recommendation, followed by the key influencing factors, and concluding with any relevant industry context. Step 510 integrates the gathered information into a coherent prompt, highlighting how the customer's payment history and invoice amount influenced the decision, and contextualizing this within industry norms. Finally, in step 512, the system optimizes the prompt for the financial manager, using language and concepts familiar to finance professionals while avoiding overly technical AI terminology. The resulting prompt may be designed to generate an explanation that not only clarifies the AI's decision-making process but also provides actionable insights for the financial manager in managing customer relationships and cash flow.

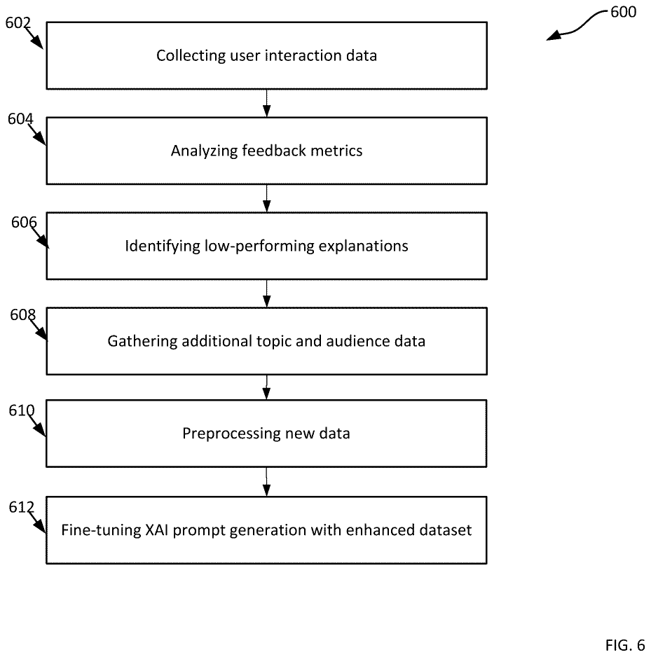

Referring to FIG. 6, a flowchart of an example method 600 of fine-tuning an XAI system according to the disclosed principles is now described. The method 600 may be implemented by the system 100 or system 200, as described above, or any other suitable system. In one or more embodiments, the method 600 includes step 602 (collecting user interaction data), step 604 (analyzing collected feedback metrics), step 606 (identifying low-performing explanations), step 608 (gathering additional topic and audience data), step 610 (preprocessing newly gathered data), and step 612 (fine-tuning XAI prompt generation).

The method 600 begins with step 602, which involves collecting user interaction data. This step may involve tracking the user's interaction with the tailored explanation provided by the system, such as the user's responses to the explanation, the user's engagement with different aspects of the explanation, or any other suitable interaction data. The user interaction data provides feedback on the effectiveness and relevance of the explanations generated by the system.

In some aspects, the collection of user interaction data in step 602 may include passive tracking methods that do not require explicit user input. For example, the system may monitor the time spent viewing different sections of the explanation, track mouse movements or clicks on specific parts of the explanation or analyze the sequence in which users navigate through the explanation. Additionally, the system may capture data on whether users seek additional information or clarification after viewing the explanation, which can indicate areas where the explanation may be lacking or unclear.

Following the collection of user interaction data in step 602, the method 600 proceeds to step 604, which involves analyzing the collected feedback metrics. This step may involve evaluating the user interaction data to assess the performance of the explanations. The feedback metrics may include measures of user satisfaction, user understanding, user engagement, or any other suitable metrics. The analysis of the feedback metrics provides insights into the strengths and weaknesses of the explanations, helping to identify areas for improvement.

In some embodiments, the analysis in step 604 may employ advanced data analytics techniques such as machine learning algorithms to identify patterns and trends in the user interaction data. These techniques may help uncover subtle relationships between explanation characteristics and user engagement that might not be apparent through simple statistical analysis. The system may also compare the performance of different explanation styles or formats across various user segments to determine which approaches are effective for specific audience types.

In step 606, the method 600 involves identifying low-performing explanations based on the analyzed feedback metrics. This step may involve determining which explanations are not meeting the user's needs or expectations, based on the feedback metrics. The identification of low-performing explanations allows the system to focus its improvement efforts on the explanations that may benefit from improvement.

In some aspects, the identification of low-performing explanations in step 606 may involve setting dynamic thresholds for performance based on historical data or benchmarks. The system may categorize explanations into different performance tiers, allowing for a nuanced approach to improvement. Additionally, the system may consider the context in which explanations are provided, such as the complexity of the underlying AI decision or the user's prior knowledge, to ensure fair comparisons when identifying low-performing explanations.

Following the identification of low-performing explanations in step 606, the method 600 proceeds to step 608, which involves gathering additional topic and audience data related to the low-performing explanations. This step may involve accessing the database 108 or 208 to retrieve additional information about the topics covered in the low-performing explanations and the audiences for these explanations. The additional topic and audience data provides further context for understanding the reasons behind the low performance of the explanations and for developing strategies to improve these explanations.

In some embodiments, the gathering of additional data in step 608 may extend beyond the system's internal database. The system may incorporate external data sources, such as industry reports, academic publications, or social media trends, to gain a more comprehensive understanding of the topics and audience preferences. This broader data collection approach may help identify emerging trends or shifts in user expectations that may inform the explanation improvement process.

In step 610, the method 600 involves preprocessing the newly gathered data. This step may involve cleaning, transforming, or otherwise preparing the additional topic and audience data for use in the fine-tuning process. The preprocessing of the new data ensures that the data may be in a suitable format and condition for effective use in the fine-tuning process.

In some aspects, the preprocessing step 610 may involve advanced data preparation techniques such as natural language processing for textual data, feature engineering to create more informative variables, or dimensionality reduction to manage high-dimensional datasets. The system may also employ data augmentation techniques to address imbalances in the dataset or to generate synthetic examples for underrepresented cases. These preprocessing steps may enhance the quality and usefulness of the data for the subsequent fine-tuning process.

The method 600 concludes with step 612, which involves fine-tuning the XAI prompt generation based on the preprocessed new data. This step may involve adjusting the XAI system's explanation generation process to improve the relevance, understandability, or other aspects of the generated explanations. The fine-tuning may be performed using machine learning techniques, optimization algorithms, or any other suitable methods. The fine-tuning process allows the system to adapt to the diverse needs and preferences of different user groups, enhancing the transparency, accountability, and user-friendliness of AI systems.

In some embodiments, the fine-tuning process in step 612 may employ transfer learning techniques, where the system leverages knowledge gained from generating explanations in one domain to improve performance in another. The system may also implement a continuous learning approach, where the fine-tuning process may be ongoing and incorporates new data in real-time, allowing for dynamic adaptation to changing user needs and preferences. Additionally, the fine-tuning process may include mechanisms for maintaining explanation consistency across different user interactions while still allowing for personalization.

In the context of the autonomous invoice reminder system, the method 600 illustrated in FIG. 6 may be applied to continuously improve the personalized explanations provided to the financial manager. The process begins with step 602, where the system collects user interaction data from the financial manager's engagement with the explanation of the AI's invoice reminder decision. This may include tracking metrics such as the time spent reviewing the explanation, specific sections the manager focuses on, or any follow-up questions asked.

Step 604 involves analyzing these collected feedback metrics to assess the effectiveness of the explanations. For instance, the system may evaluate whether the financial manager consistently requests additional information about aspects of the explanation, indicating potential areas of confusion or insufficient detail. In step 606, the system identifies low-performing explanations based on this analysis. These may be explanations that consistently lead to requests for clarification or those that do not result in the expected actions from the financial manager.

The subsequent steps focus on improving the explanation generation process. In step 608, the system gathers additional data related to the identified low-performing explanations. This may include more detailed information about invoice management practices in the company's industry or updated data on the financial manager's evolving needs and preferences. Step 610 involves preprocessing this newly gathered data, which may include normalizing financial data or categorizing industry-specific information. Finally, in step 612, the system fine-tunes its XAI prompt generation process using this enhanced dataset. This fine-tuning may involve adjusting the language model to better incorporate financial terminology or modifying the explanation structure to prioritize actionable information for the financial manager.

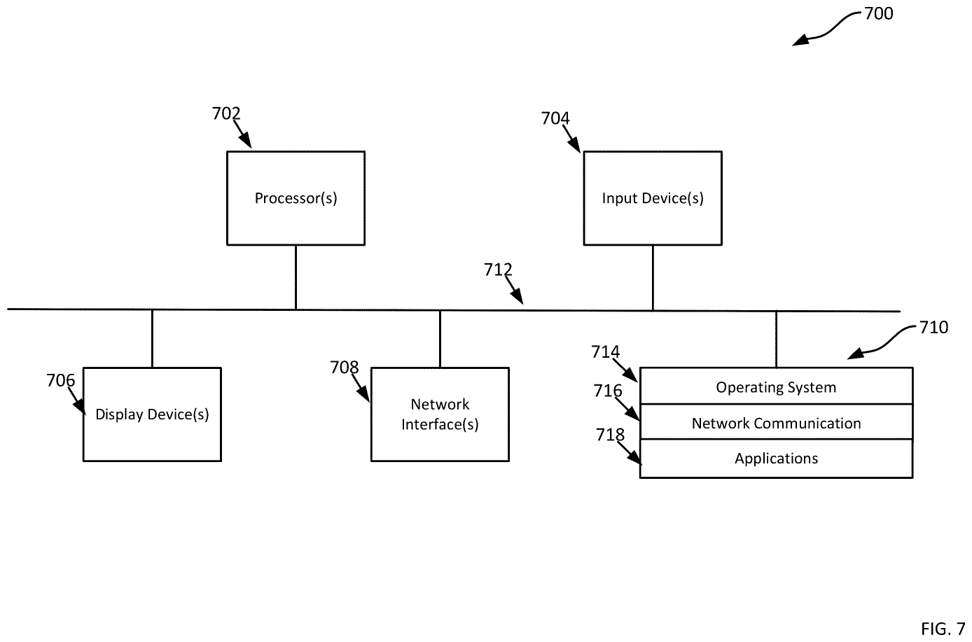

Referring to FIG. 7, a block diagram of a system 700 for implementing the personalized XAI methods is illustrated. The system 700 may include several components interconnected via a system bus 712. The system 700 comprises a processor 702, which is connected to the system bus 712. The processor 702 may be a central processing unit (CPU), a graphics processing unit (GPU), or any other suitable processing device. In some aspects, the processor 702 may be configured to execute instructions stored in a memory to perform various operations, such as fitting an inference model, performing inference, extracting SHAP values, generating personalized explanation prompts, producing tailored explanations, collecting user feedback, and fine-tuning the XAI system.

An input device 704 is also connected to the system bus 712, allowing for user input to be received by the system 700. The input device 704 may be a keyboard, a mouse, a touchscreen, a microphone, or any other suitable input device. In some embodiments, the input device 704 may be used by a user to interact with the system 700, such as to provide input data, receive output data, or provide feedback on the system's performance.

A display device 706 is connected to the system bus 712, providing visual output capabilities for the system 700. The display device 706 may be a monitor, a projector, a virtual reality headset, or any other suitable display device. In some aspects, the display device 706 may be used to present the tailored explanations generated by the system 700 to the user.

The system 700 also may include a network interface 708 connected to the system bus 712, enabling communication with external networks or devices. The network interface 708 may be a network adapter, a wireless network adapter, a modem, or any other suitable network interface device. In some embodiments, the network interface 708 may be used to connect the system 700 to a network, such as the internet, a local area network (LAN), a wide area network (WAN), or any other suitable network.

A software stack 710 is shown, which may include multiple layers of software components. The software stack 710 comprises an operating system 714 at its base, providing system management and control functions. Above the operating system 714 is a network communication layer 716, facilitating network-related operations. At the top of the software stack 710 are applications 718, which represent various software programs or services that can be executed on the system 700. These applications 718 may include the XAI system, the LLM system, and any other suitable applications.

The system bus 712 serves as the central communication pathway, allowing data and control signals to be exchanged between the various components of the system 700. This architecture enables the processor 702 to interact with the input device 704, display device 706, and network interface 708, while also executing the software components within the software stack 710.

In some aspects, the system 700 may be configured to continuously improve its explanations based on user feedback. For example, the system 700 may collect user feedback via the input device 704, analyze the feedback to identify low-performing explanations, gather additional topic and audience data related to the low-performing explanations, and fine-tune the XAI system using the additional data to improve explanation generation. This feedback loop mechanism allows the system 700 to adapt to the diverse needs and preferences of different user groups, enhancing the transparency, accountability, and user-friendliness of AI systems across diverse applications and user groups.

In some aspects, the personalized explainer system may be model-agnostic, meaning it may be applied to various AI systems across different domains. This feature may enhance the scalability of the system, allowing it to be used in a wide range of applications, from autonomous invoice reminder systems to medical diagnosis support systems. Regardless of the specific AI model or domain, the system may generate personalized, understandable explanations that enhance user confidence in AI-driven decisions. The model-agnostic nature of the system may allow it to adapt to new AI models and domains as they emerge, providing a flexible solution for XAI across diverse fields. Additionally, this approach may facilitate comparisons between different AI models within the same domain, as the explanation generation process remains consistent across various model architectures. In some embodiments, the system's ability to work with multiple AI models may enable organizations to standardize their explainability practices across different departments or projects, promoting consistency in how AI decisions are communicated to stakeholders.

While the foregoing is directed to example embodiments described herein, other and further example embodiments may be devised without departing from the basic scope thereof. For example, aspects of the present disclosure (e.g., modules) may be implemented in hardware or software or a combination of hardware and software. One example embodiment described herein may be implemented as a program product for use with a computer system. The program(s) of the program product defines functions of the example embodiments (including the methods described herein) and may be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid-state random-access memory) on which alterable information is stored. Such computer-readable storage media, when carrying computer-readable instructions that direct the functions of the disclosed example embodiments, are example embodiments of the present disclosure.

It will be appreciated by those skilled in the art that the preceding examples are not limiting. It is intended that permutations, enhancements, equivalents, and improvements thereto are apparent to those skilled in the art upon a reading of the specification and a study of the drawings are included within the true spirit and scope of the present disclosure. It is therefore intended that the following appended claims include such modifications, permutations, and equivalents as fall within the true spirit and scope of these teachings.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed:

1. A system for generating personalized explanations for artificial intelligence (AI) model predictions, comprising:
a processor; and
a memory storing instructions that, when executed by the processor, cause the system to:
perform an inference with an inference model;
extract Shapley (SHAP) values of corresponding features used by the inference model for the inference;
generate, by an explainable AI (XAI) module, a personalized explanation prompt based on the corresponding features and contextual information of a target audience; and
produce, by a large language model (LLM), a tailored explanation of the inference to the target audience based on the generated prompt.

2. The system of claim 1, wherein the system is further configured to extract the SHAP values by:
analyzing the inference model's inference;
calculating the SHAP values for the corresponding features used in the inference model;
ranking the corresponding features based on their absolute SHAP values; and
selecting a predetermined number of top positive and negative SHAP values.

3. The system of claim 2, wherein the system is further configured to generate the personalized explanation prompt by:
retrieving the selected SHAP values and the corresponding features;
gathering additional user context;
incorporating domain-specific information; and
integrating the corresponding features, user context, and the domain-specific information into the prompt.

4. The system of claim 1, wherein the system is further configured to fine-tune the XAI by:
analyzing the collected user feedback to identify low-performing explanations;
gathering additional topic and audience data related to the low-performing explanations; and
updating the XAI using the additional data to improve explanation generation.

5. The system of claim 4, wherein the system is further configured to analyze the collected user feedback by evaluating user interaction metrics with the tailored explanations.

6. The system of claim 1, wherein the tailored explanation comprises a natural language description of corresponding features and their impact on the inference model's inference.

7. The system of claim 1, wherein the system is further configured to adjust a level of detail in the tailored explanation based on a technical expertise level of the target audience.

8. The system of claim 1, wherein the system is further configured to generate multiple explanations with varying levels of complexity and present them to the user for selection.

9. The system of claim 1, wherein the system is further configured to collect user feedback on the tailored explanation and fine tune the XAI based on the collected feedback.

10. The system of claim 1, wherein the system is further configured to use the feedback for fine-tuning by:
tracking user engagement with different aspects of the explanations;
identifying patterns in user preferences across different audience segments; and
adjusting a prompt generation strategy of the XAI based on the identified patterns.

11. A method of generating personalized explanations for artificial intelligence (AI) model predictions, comprising:
performing inference with an inference model;
extracting Shapley (SHAP) values of corresponding features used by the inference model for the inference;
generating, by an explainable AI (XAI) module, a personalized explanation prompt based on the corresponding features and contextual information of a target audience; and
producing, by a large language model (LLM), a tailored explanation of the inference to the target audience based on the generated prompt.

12. The method of claim 11, wherein extracting the SHAP values comprises:
analyzing the inference model's inference;
calculating the SHAP values for the corresponding features used in the inference model;
ranking the corresponding features based on their absolute SHAP values; and
selecting a predetermined number of top positive and negative SHAP values.

13. The method of claim 12, wherein generating the personalized explanation prompt comprises:
retrieving the selected SHAP values and the corresponding features;
gathering additional user context;
incorporating domain-specific information; and
integrating the corresponding features, user context, and the domain-specific information into the prompt.

14. The method of claim 11, wherein fine-tuning the XAI comprises:
analyzing the collected user feedback to identify low-performing explanations;
gathering additional topic and audience data related to the low-performing explanations; and
updating the XAI using the additional data to improve explanation generation.

15. The method of claim 14, wherein analyzing the collected user feedback comprises evaluating user interaction metrics with the tailored explanations.

16. The method of claim 11, wherein the tailored explanation comprises a natural language description of the corresponding features and their impact on the inference model's inference.

17. The method of claim 11, further comprising adjusting a level of detail in the tailored explanation based on a technical expertise level of the target audience.

18. The method of claim 11, further comprising generating multiple explanations with varying levels of complexity and presenting them to the user for selection.

19. The method of claim 11, further comprising collecting user feedback on the tailored explanation and fine tuning the XAI based on the collected feedback.

20. The method of claim 11, wherein the feedback for fine-tuning comprises:
tracking user engagement with different aspects of the explanations;
identifying patterns in user preferences across different audience segments; and
adjusting a prompt generation strategy of the XAI based on the identified patterns.
